(19) United States
(12) Patent Application Publication
(10) Pub. No.: US 2011/0047960 A1
(43) Pub. Date: Mar. 3, 2011

(54) DUAL-FLOW TURBINE ENGINE FOR AIRCRAFT WITH LOW NOISE EMISSION

(75) Inventors: Jérôme Huber, Toulouse (FR); Klaus Debatin, Bonrepos Sur Aussonnelle (FR); Amadou André, Toulouse (FR); Olivier Pelagatti, Toulouse (FR)

(73) Assignees: AIRBUS OPERATIONS (SAS), Toulouse (FR); AIRBUS (SAS)

(21) Appl. No.: 12/990,733

(22) PCT Filed: Apr. 30, 2009
(86) PCT No.: PCT/FR09/00515

§ 371 Date: Nov. 2, 2010

(30) Foreign Application Priority Data
May 7, 2008 (FR) 0802540

(51) Int. Cl. F02K 3/02

(52) U.S. Cl. 60/226.1

(57) ABSTRACT

The invention relates to a dual-flow turbine engine for an aircraft with low noise emission, wherein the opening (6) for the cold flow (9) of the turbine engine is provided with short, narrow, and spaced chevrons (15) that penetrate deeply, like claws, into said cold flow (9).

The present invention relates to a dual-flow turbine engine for an aircraft with low noise emission.

It is known that, at the back of a nozzle, the jet emitted by the latter comes into contact with at least another gas flow: in the case of a simple flow turbine engine, the latter comes into contact with the ambient air, whereas, in the case of a dual-flow turbine engine, the cold flow and the hot flow come into contact, not only one with the other, but also with the ambient air.

As the velocity of the jet emitted by said nozzle is different from the velocity of said other gas flows being met by said jet, as a result penetration fluid shears occur between said flows, said fluid shears generating noise, generally referred to as “jet noise” in the aeronautic art.

In order to reduce such a jet noise, it has already been contemplated to generate some turbulence at the limits between said flows having different velocities in order to quickly mix them.

For example, document GB-A-766,985 describes a nozzle having its outlet hole provided, at the periphery thereof, with a plurality of projections extending to the back and having the general direction being at least approximately that of the jet emitted by said nozzle. Such projections consist in “teeth” being able to have numerous different shapes.

Alternatively, document GB-A-2,289,921 suggests providing indentations in the outlet hole edge of the nozzle. Such indentations are distributed at the periphery of said outlet hole and each of them has generally the at least approximate shape of a triangle, the base of which is merged with said edge of the outlet hole and the apex of which is located in front of such an outlet edge. As a result, between two consecutive indentations, a tooth is formed having the at least approximate shape of a triangle or a trapezoid.

Such projecting teeth are generally referred to as “chevrons” in the aeronautic art, whatever their precise shape.

In dual-flow turbine engines, such chevrons are commonly arranged as well at the rear of the hot nozzle as at the rear of the cold nozzle.

However, it can be easily established that, if the known chevrons are generally efficient for attenuating the jet noise from the hot nozzle, on the other hand, they are much less efficient as regards noise emitted by the cold nozzle.

This is probably due to the fact that, as a result of a static pressure discontinuity between the external pressure and the pressure at the outlet of the cold nozzle, such a supersonic cold flow generates a series of compression-vacuum relief cells (velocity oscillations) acting as noise amplifiers and producing a noise referred to as a “shock cell noise” in the aeronautic art. Now, it seems that the chevrons a cold nozzle is provided with, although being efficient for attenuating the jet noise while creating some turbulence promoting the blend of the cold flow and of the external aerodynamic flow, only produce little effect in the reduction of the shock cell noise.

The present invention aims at solving such a drawback.

To this end, according to the invention, the dual-flow turbine engine for an aircraft, comprising, around its longitudinal axis:
a pod provided with an external pod hood and enclosing a fan generating the cold flow and a central generator generating the hot flow;
a cold flow ring channel arranged around said central hot flow generator;
an external fan hood bounding said cold flow ring channel on said external pod hood side;
a cold flow outlet hole, having its edge being determined by said external pod hood and by said external fan hood converging one toward the other; and
a plurality of chevrons distributed around said edge of the cold flow outlet hole, projecting to the rear of said turbine engine,
   is remarkable in that:
said chevrons are two by two spaced apart by arranging passages therebetween;
each chevron is tilted in the direction of said longitudinal axis so as to penetrate through said cold flow with a penetration angle being, as measured from said external fan hood, at least approximately equal to 30°; and
said penetration angle and the length of each chevron from said edge of the cold flow outlet hole are selected so that the penetration height thereof in said cold flow ranges between 0.01 time and 0.03 time the diameter of said cold flow outlet hole.

Thanks to this invention, the periphery of said cold flow is subjected, at the outlet of the corresponding nozzle, to a division into jets with different orientations and structures, depending on whether said jets pass on the strongly penetrating chevrons, although of a relatively low length, or in the passages being located between said chevrons. Indeed, the cold flow jets passing through said passages have a direction extending said external fan hood and have, at the edge of said cold flow outlet hole, an acceleration value equal to the nominal value of the nozzle. On the other hand, the cold flow jets passing on the chevrons are strongly diverted to the axis of said turbine engine and deeply penetrate into said cold flow.

Thus, said penetrating chevrons according to the present invention:
induce radial heterogeneities in the cold flow pressure field at the outlet of the fan nozzle, that is they locally disorganize the structure of said cold flow, resulting, at the rear of the turbine engine, in a reduction of the intensity of the shock cells and therefore, of the amplitude of the velocity oscillations; and, concurrently
improve the blend between the cold flow and the aerodynamic flow around the turbine engine, resulting in a reduction of the jet noise.

The chevrons according to the present invention thus allow to impact, both, on the turbulence (source of noise) and on the shock cells (amplification of such a noise).

Preferably, the length of each chevron is at the most equal to 150 mm.

When, as known, each chevron has the at least approximate shape of a trapezoid with lateral sides converging one to the other while being spaced apart from said edge of the cold flow outlet hole, it is advantageous that each of said lateral sides of the chevrons forms, with said edge, an angle ranging between 125° and 155°.

From the foregoing, it is easy to understand that said chevrons of the present invention are short and narrow and, in a claw fashion, strongly penetrate through the cold flow. Thus, in order to limit the aerodynamic losses, it is advantageous that the space between two consecutive chevrons is higher than 1.5 times the width of one chevron along said edge of the cold flow outlet hole. Such a space is preferably approximately equal to twice said width of one chevron.

In order to further reduce the jet noise when each chevron has the at least approximate shape of a trapezoid as mentioned hereinabove, it is advantageous that the small base of said trapezoid, spaced from said edge of the cold flow outlet hole, comprises a central indentation. As a result, said small base comprises two side projections separated by said central indentation. Thus, swirls are caused to be formed, improving the blend between the external aerodynamic flow and said cold flow.

Indeed, each of the side projections of such a chevron generates a swirl, both swirls of one chevron being entangled and counter-rotating. The set of said chevrons thus generates a swirl system quickly homogenizing the gas flows at the rear of the nozzle. Thus, as a result, a quick attenuation of the jet noise occurs.

Furthermore, in order to avoid the edge effects and the formation of interference acoustic sources, it is advantageous that each chevron has a rounded shape. To this end:
the small base of the trapezoid is wavy forming two rounded side bumps (the projections) separated by said indentation, also with a rounded shape; and
each of the lateral sides of the chevrons is connected to the edge of the cold flow outlet hole by a rounded concave line.

The figures of the appended drawing will better explain how this invention can be implemented. In these figures, like reference numerals relate to like components.

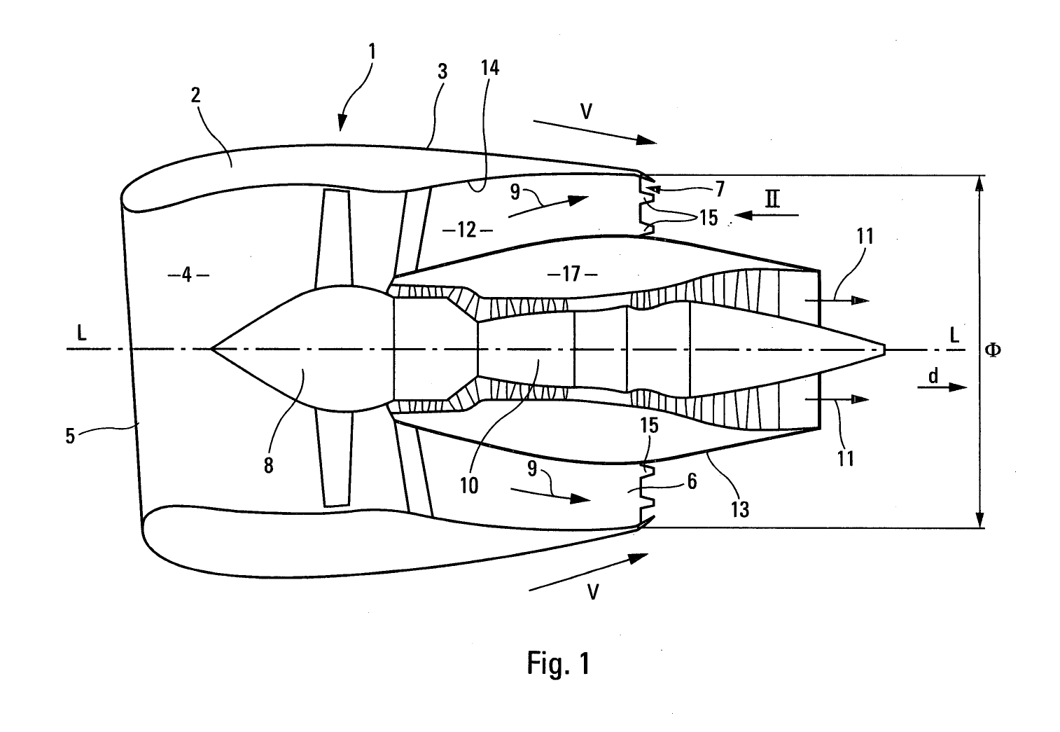

FIG. 1 represents, in a schematic axial section, an improved turbine engine according to the present invention.

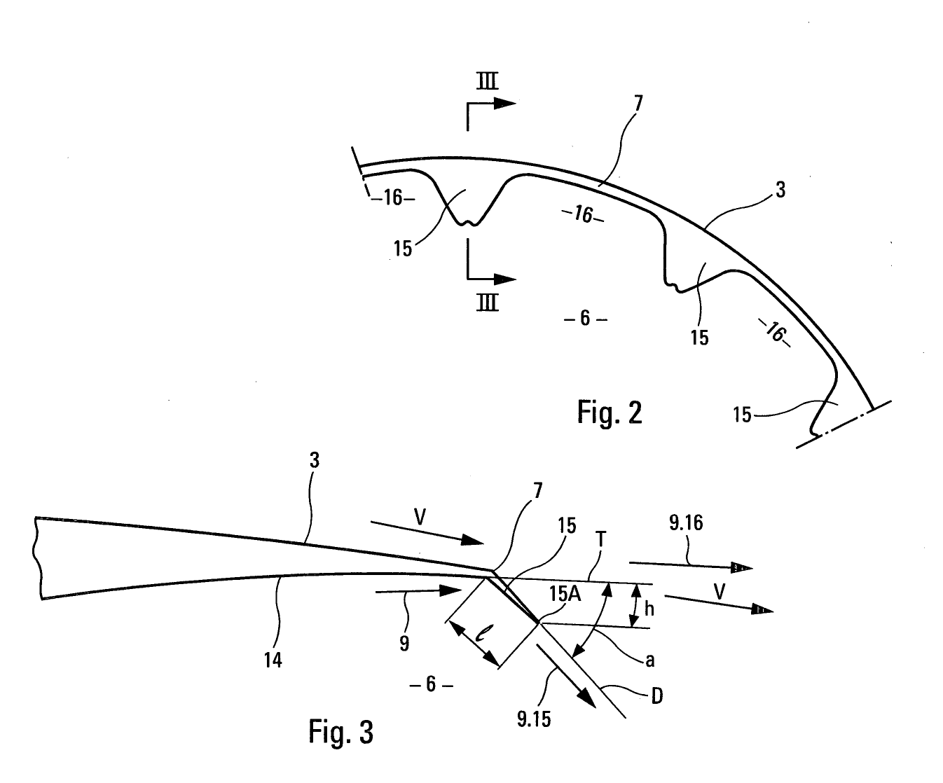

FIG. 2 is a schematic and partial view, from the rear, of the cold flow nozzle of the turbine engine of FIG. 1, seen along the arrow II of this latter figure.

FIG. 3 is a schematic section taken along the line III-III of FIG. 2.

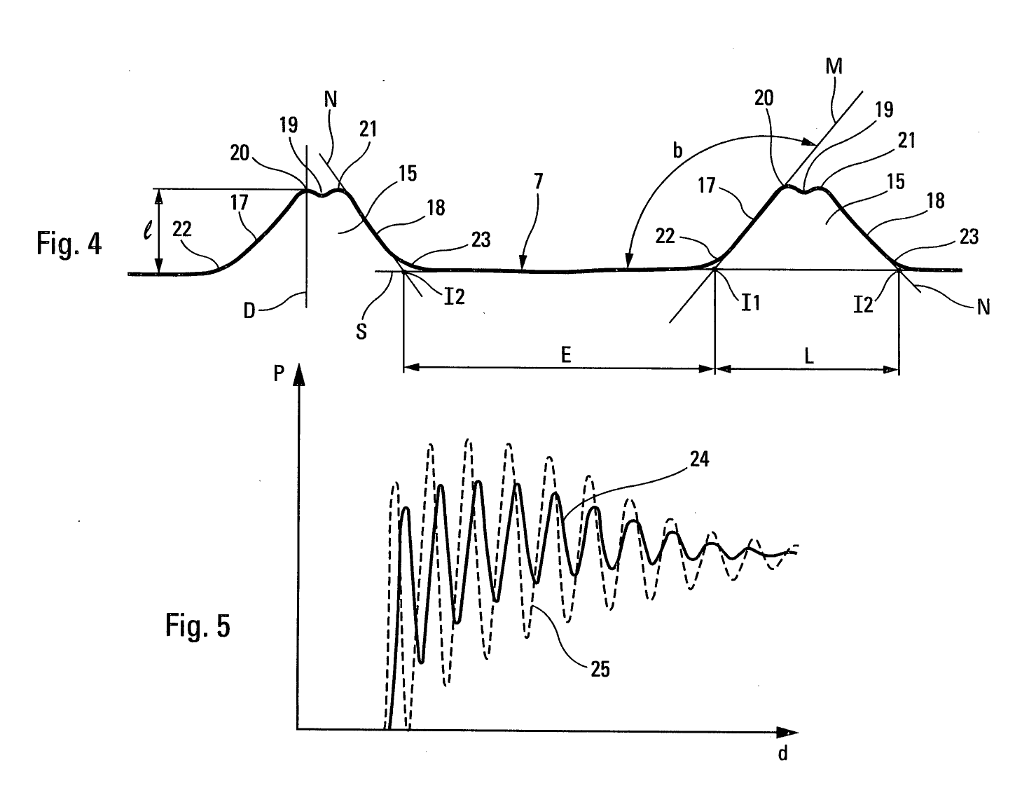

FIG. 4 is a partial schematic planar view of the edge of the outlet hole of the cold flow nozzle provided with chevrons according to the present invention.

FIG. 5 is a diagram indicating, for a known engine and for this same known engine being improved according to the invention, the variation of pressure P at the rear of said engine, as a function of the distance d along the axis of the latter.

The dual-flow turbine engine 1, with a longitudinal axis L-L and shown on FIG. 1, comprises a pod 2 bounded by an external pod hood 3.

The pod 2 comprises, in the front, an air input 4 provided with a leading edge 5 and, on the rear, an air outlet hole 6 having the diameter Φ and bounded by an edge 7 acting as a trailing edge for said pod.

Inside said pod 2, there are arranged:
a fan 8 directed to the air input 4 and being able to generate the cold flow 9 for the turbine engine 1;
a central generator 10, comprising, as known, low and high pressure compressors, a combustion chamber and low and high pressure turbines, and generating the hot flow 11 of said turbine engine 1; and
a cold flow ring channel 12, arranged around said central generator 10, between an internal fan hood 13 and an external fan hood 14.

The external fan hood 14 forms a nozzle for the cold flow and converges, to the rear of the turbine engine 1, in the direction of said external pod hood 3, so as to form with the latter the edge 7 of said hole 6, thus making up the cold flow outlet hole.

A plurality of chevrons 15 are distributed on said edge 7 of the hole 6, around said axis L-L, projecting to the rear of the turbine engine 1.

As shown on FIG. 2, the chevrons 15 are spaced apart two by two while arranging therebetween passages 16. Moreover, each chevron 15 is tilted in the direction of the longitudinal axis L-L so as to penetrate through said cold flow 9 with a penetration angle a (see FIG. 3). As measured from the external fan hood 14, the penetration angle a is at least equal to 20°, and, preferably, in the order of 30°.

A penetration angle a refers to the angle defined by the tangent T to the external hood 14, in the vicinity of the edge 7, and the general direction D of the external surface of the chevron 15.

The length l of each chevron 15 from the edge 7 of the outlet hole 6 ranges between 0.03 time and 0.06 time the diameter Φ thereof. Such a length l is, for example, at the most equal to 150 mm.
The term length l of a chevron 15 refers to the distance between the edge 7 of the hole 6 and the distal end 15A of the chevron 15, with respect to said edge 7, in the general direction D of the chevron 15 (see FIG. 3); and
the term diameter Φ of the outlet hole 6 refers to the internal diameter defined by the edge 7 of the hole 6, upstream the chevrons 15 (see FIG. 1).

Furthermore, the penetration angle a and the length l are such that the radial penetration height h of the chevrons 15 through the cold flow 9 ranges between 0.01 time and 0.03 time said diameter Φ of the cold flow outlet hole 6.

As shown on FIG. 4, each chevron 15 has the at least approximate shape of a trapezoid with lateral sides 17, 18 converging one to the other while going away from the edge 7 of the cold flow hole 6. Each of the lateral sides 17, 18 forms, together with said edge 7, an angle b ranging between 125° and 155°.

Moreover, the space E between two consecutive chevrons 15 along the edge 7 is higher than 1.5 times the width L of the chevrons 15 at the level of said edge 7. The space E could be approximately twice the width L.

According to the partial schematic planar view of the edge 7 of the outlet hole 6 provided with the chevrons 15 of FIG. 4,
the term angle b refers to the angle defined by the tangent S of the edge 7 and the straight line M, N extending a lateral side 17, 18 of a chevron 15;
the width L of a chevron 15 refers to the distance separating the intersection 11 of the right line M, extending a lateral side 17 of a chevron 15, with the tangent S of the edge 7 and the intersection 12 of the right line N, extending the other lateral side 18 of the chevron 15, with the tangent of the edge 7; and
the space E refers to the distance separating the intersection 11 of the right line M, extending a lateral side 17 of a chevron 15, with the tangent S of the edge 7 and the intersection 12 of the right line N, extending a lateral side 18 of an adjacent chevron 15, with the tangent S of the edge 7.

The small base of the chevrons 15, being spaced apart from the edge 7, comprises a central indentation 19. As a result, such a small base has two side projections 20 and 21 separated by said indentation 19. As shown, the indentation 19 and the side projections 20 and 21 are rounded, so that said small base is wavy with two side bumps (the projections 20 and 21) separated by the indentation 19.

Furthermore, each of the lateral sides 17, 18 of the chevrons 15 is connected to the edge 7 of the hole 6 by a rounded concave line 22 or 23, respectively.

When the aircraft (not shown) carrying the turbine engine 1 moves, an aerodynamic flow V occurs around the pod 2, upon contact with the external pod hood 3 (see FIGS. 1 and 3). Furthermore, as illustrated on FIG. 3, at the periphery of the cold flow 9, jets 9.15 thereof are diverted by said chevrons 15 in the direction of the axis L-L of the turbine engine 1, whereas other jets 9.16 of said cold flow pass between the chevrons 15, through the passages 16, extending the external fan hood 14, the acceleration of the jets 9.15 being much higher than that of the jets 9.16.

Thanks to the swirls generated by the bumps 20 and 21 of the chevrons 15, an excellent blend is produced between the cold flow 9 and the aerodynamic flow V. The jet noise is therefore reduced. In addition, because of the difference of the accelerations of the jets 9.15 and 9.16 at the outlet of the hole 6, the cold flow 9 is getting de-structured at least in the periphery, so that the noise shock cells are reduced.

This consequence is shown on FIG. 5.

This FIG. 5 shows the results of trials on a turbine engine equipping a long-distance airplane. This FIG. 5 is a graph showing the pressure oscillations P at the rear of the turbine engine depending on the distance d to the latter.

The curve 24 in solid lines on FIG. 5 corresponds to said turbine engine being improved according to the invention by arranging 14 chevrons 15 regularly distributed at the periphery of the outlet hole of the external fan hood thereof, so as to provide as many passages 16.

On the other hand, the curve 25 in broken lines on FIG. 5 corresponds to the same non improved turbine engine according to the invention.

Comparing the curves 24 and 25, it can be seen that the present invention enables to reduce by approximately 20% the amplitude of such pressure oscillations.

1. A dual-flow turbine engine for an aircraft, comprising, around the longitudinal axis (L-L) thereof:
a pod (2) provided with an external pod hood (3) and enclosing a fan (8) generating the cold flow (9) and a central generator (10) generating the hot flow (11);
a cold flow ring channel (12) arranged around said central hot flow generator (10);
an external fan hood (14) bounding said cold flow ring channel (12) on said external pod hood (3) side;
a cold flow outlet hole (6), having its edge (7) determined by said external pod hood (3) and by said external fan hood (14) converging one toward the other; and
a plurality of chevrons (15) distributed around said edge (7) of the cold flow outlet hole (6), projecting to the rear of said turbine engine,
wherein:
said chevrons (15) are spaced apart two by two with a space (E) while arranging passages (16) therebetween;
each chevron (15) is tilted in the direction of said longitudinal axis (L-L) so as to penetrate through said cold flow (9) with a penetration angle (a) being, as measured from said external fan hood (14), at least approximately equal to 30°; and
said penetration angle (a) and the length (f) of each chevron (15) from said edge (7) of the cold flow outlet hole (6) are selected so that the penetration height (h) of the latter into said cold flow (9) ranges between 0.01 time and 0.03 time the diameter (Φ) of said cold flow outlet hole (6).

2. The turbine engine according to claim 1: wherein the length (l) of each chevron (15) is at the most equal to 150 mm.

3. The turbine engine according to claim 1, wherein each chevron (15) has the at least approximate shape of a trapezoid with lateral sides (17, 18) converging one to the other while going away from said edge (7) of the cold flow outlet hole (6), wherein each of said lateral sides (17, 18) of the chevrons (15) forms, with said edge (7), an angle (b) ranging between 125° and 155°.

4. The turbine engine according to claim 1, wherein the space (E) between two consecutive chevrons (15) is higher than 1.5 times the width (L) of one chevron (15) along said edge (7) of the cold flow outlet hole (6).

5. The turbine engine according to claim 1, wherein said space (E) is approximately equal to twice said width (L) of one chevron.

6. The turbine engine according to claim 1, wherein each chevron (15) has the at least approximate shape of a trapezoid with lateral sides (17, 18) converging one to the other while going away from said edge (7) of the cold flow outlet hole (6), wherein the small base of said trapezoid, spaced from said edge (7), comprises a central indentation (19).

7. The turbine engine according to claim 6, wherein said small base of the trapezoid is wavy while forming two rounded side bumps (20, 21) separated by said central indentation (19), also rounded.

8. The turbine engine according to claim 3, wherein each of said lateral sides (17, 18) of the chevrons (15) is connected to said edge (7) of the cold flow outlet hole (6) by a rounded concave line (22, 23).
